(19) United States
(12) Patent Application Publication
(10) Pub. No.: US 2019/0092312 A1
(43) Pub. Date: Mar. 28, 2019

(54) MULTI-MODE CVT CONTROLLER

(71) Applicant: TEAM Industries, Inc., Bagley, MN (US)

(72) Inventors: John Edward Hamrin, Bagley, MN (US); Bruce H. Younggren, Bagley, MN (US); Gary Allen Johnson, Mahnomen, MN (US); Carlos Romo, Bemidji, MN (US); Javier Solis, Leander, TX (US)

(73) Assignee: TEAM Industries, Inc., Bagley, MN (US)

(21) Appl. No.: 16/141,255

(22) Filed: Sep. 25, 2018

Related U.S. Application Data
(60) Provisional application No. 62/563,493, filed on Sep. 26, 2017.

(51) Int. Cl. B60W 10/08; F16H 61/662; F16H 61/664

(52) U.S. Cl. CPC B60W 10/08; F16H 61/66259; F16H 2061/661; F16H 61/6648; F16H 61/66272

(57) ABSTRACT

A control system for a continuously variable transmission (CVT) is provided. The control system includes a shift mode switch, an actuator and a controller. The shift mode switch is selectable between a plurality of modes. The actuator is in operational communication with the CVT to selectively override normal shifting characteristics of the CVT. The controller is in communication with the shift mode switch. The controller is configured to control the actuator to selectively override the normal shifting characteristics of the CVT based at least in part on a select mode configuration selected by the shift mode switch.

### CROSS-REFERENCE TO RELATED APPLICATIONS

This Application claims priority to U.S. Provisional Application Ser. No. 62/563,493, same title herewith, filed on Sep. 26, 2017, which is incorporated in its entirety herein by reference.

### BACKGROUND

A continuously variable transmission CVT has the ability to continuously change a gear ratios based at least in part on a then current torque experienced by the CVT. One type of a CVT is a belt CVT. A belt CVT includes a primary clutch (drive clutch) and a secondary clutch (driven clutch) that are in rotational communication with each other via a belt or other type of endless loop device. The primary clutch is coupled to receive torque provided by an engine while secondary clutch is coupled to a drivetrain of a vehicle which may include a further portions of a transmission and gearing. The primary clutch and secondary clutch are designed to change gear ratios based on the torque that they are experiencing. In particular, in response the torque, a movable sheave portion is moved away from or towards a fixed sheave portion of the respective primary and secondary clutches to move the belt towards or away from a rotational axis of the respective primary and secondary clutches. Another type of CVT is a NuVinci CVT or NuVinci continuously variable planetary (CVP). In this design, gear ratio control is accomplished by changing relative angles of a pair of carriers engaging balls in response to a current torque experienced by the CVT.

### SUMMARY

The following summary is made by way of example and not by way of limitation. It is merely provided to aid the reader in understanding some of the aspects of the subject matter described. Embodiments provide a multi-position switch controller configuration that selectively controls shift qualities of the CVT.

In one embodiment, a control system for a continuously variable transmission (CVT) is provided. The control system includes a shift mode switch, an actuator and a controller. The shift mode switch is selectable between a plurality of modes. The actuator is in operational communication with the CVT to selectively override normal shifting characteristics of the CVT. The controller is in communication with the shift mode switch. The controller is configured to control the actuator to selectively override the normal shifting characteristics of the CVT based at least in part on a select mode configuration selected by the shift mode switch.

In another embodiment, a vehicle including a motor to generate engine torque, a drivetrain; a continuously variable transmission (CVT), a shift mode switch, an activator and a controller is provided. The CVT is positioned to communicate torque between the motor and the drivetrain at a select ratio. The shift mode switch is selectable between a plurality of modes. The actuator is in operational communication with the CVT to selectively override normal shifting characteristics of the CVT. The controller is in communication with the shift mode switch. The controller is configured to control the actuator to selectively override the normal shifting characteristics of the CVT based at least in part on a select mode configuration selected by the shift mode switch.

In still another embodiment, a method of controlling a continuously variable transmission (CVT) is provided. The method includes detecting the activation of a multi-mode shift mode switch; and implement operating instructions to adjust a shifting characteristics of the CVT associated with a mode indicated by the activated shift mode switch based at least in part on the position of the activated shift mode switch.

### BRIEF DESCRIPTION OF THE DRAWINGS

Embodiments can be more easily understood and further advantages and uses thereof will be more readily apparent, when considered in view of the detailed description and the following figures in which:

FIG. 1 is an illustration of a vehicle dashboard including a mode switch according to one exemplary embodiment;

FIG. 2 is a block diagram of a vehicle including a CVT and a multi-mode CVT controller according to one exemplary embodiment;

FIG. 3 is a cross-sectional side view of a CVT according to one exemplary embodiment;

FIG. 4 is an operating mode flow diagram according to one exemplary embodiment;

FIG. 5 illustrates a shift table according to one exemplary embodiment;

FIG. 6 illustrates a graphical shift table according to one exemplary embodiment; and

FIG. 7 illustrates a shift table graph according to one exemplary embodiment.

In accordance with common practice, the various described features are not drawn to scale but are drawn to emphasize specific features relevant to the subject matter described. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the embodiments, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments provide a vehicle with a multi-position switch that allows for the controlling of shift qualities, such as the gear ratio, of a CVT. This is especially useful for all terrain vehicles (ATV) and side by side utility task vehicles (UTV) and the like, where a deviation from the normal shift qualities of the CVT may be desired. Embodiments can be applied to any CVT design including, but not limited to, belt CVT with flywheel and Nu Vinci CVT (Continuously Variable Planetary (CVP)) designs.

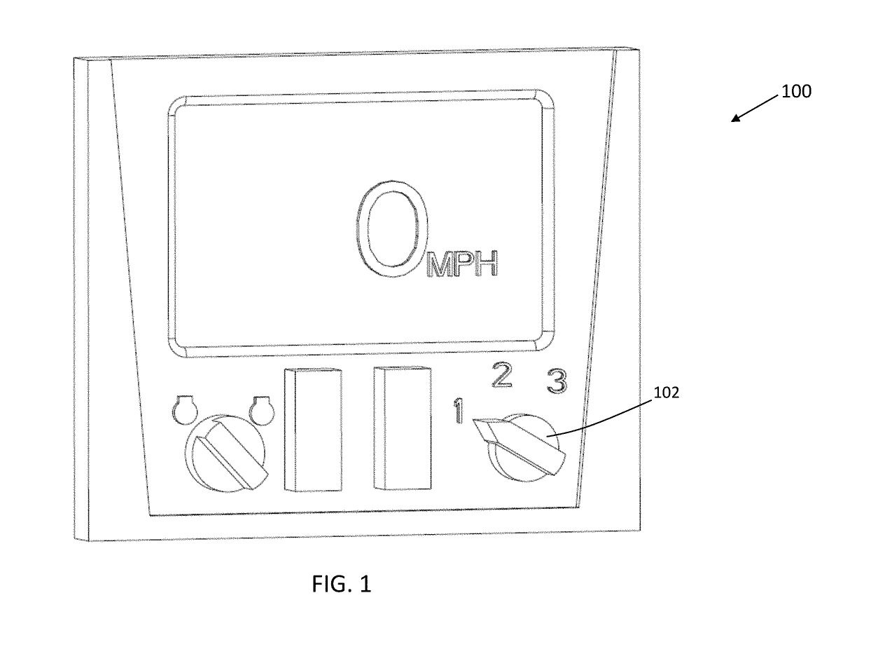

In an embodiment a multi-position shift mode switch on the vehicle provides a selection input to controller, such as, but not limited to, a microprocessor of a transmission control unit. Each selection input is associated with a set of parameters that affect the shift qualities of the CVT. In embodiments, the parameters may change normal operating characteristics of the CVT associated with engine revolutions per minute (RPM). An operator may toggle, switch, the shift mode switch based on given riding conditions. Referring to FIG. 1, an example of a vehicle dashboard 100 is illustrated with a shift mode switch 102. The shift mode switch 102 in this example embodiment has three different positions.

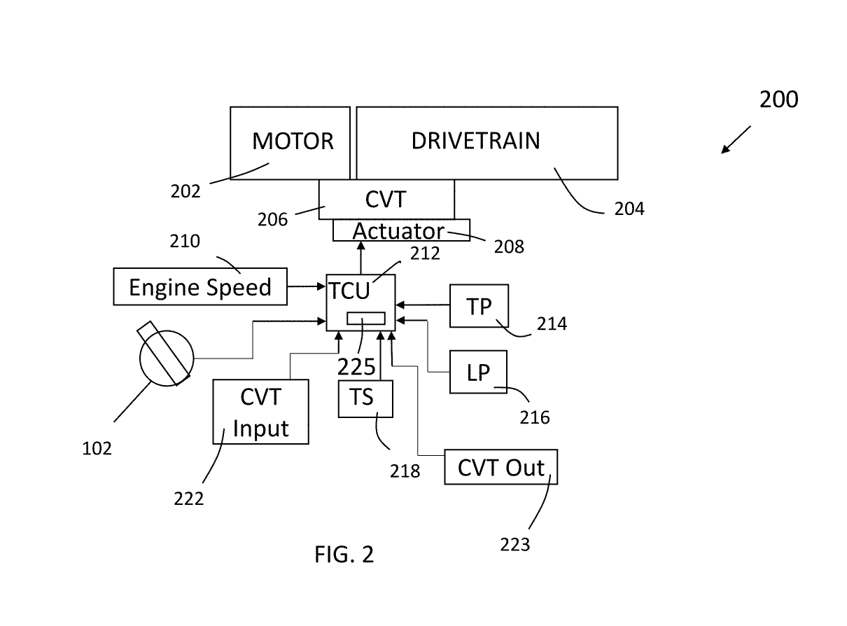

A block diagram of a vehicle 200 implementing a multi-mode CVT control system of an embodiment is illustrated in FIG. 2. The vehicle 200 is illustrated as including a motor 202, a CVT 206 and a drivetrain 204. The motor 202 provides torque to the CVT 206. The motor 202 may be an internal combustion engine, an electrical motor or any other type of motor that generates engine torque. In response to the motor torque the CVT 206 provides torque at a select ratio to the drivetrain 204. The drivetrain 204 in this example, may include further transmission portions, drive shafts, half shafts, gear cases, differentials, wheels etc.

Vehicle 200 includes a mode control system which in this embodiment includes a shift mode switch 102 (discussed above), a controller 212, such as a transmission control unit (TCU) 212 and an actuator 208. Examples of the different modes provided by the shift mode switch 102 is described below. An operator, or user, of the vehicle controls the positioning of the shift mode switch 102 in an embodiment. The controller 212 is in communication with the shift mode switch 102 to detect the then current position of the shift mode switch 102. The controller 212 includes further inputs. For example, inputs to the controller 212 in this example embodiment includes inputs from an engine speed sensor 210, a CVT input speed sensor 222, a CVT output speed sensor 223, a temperature sensor 218, a lubrication pressure sensor 216 and a throttle position sensor 214. Based on the position of the mode shift control 102 and inputs from the sensors 210, 222, 223, 218, 216 and 214, instructions and algorithms stored in memory 225, the TCU 212 controls an actuator 208 to selectively alter the base (normal) characteristics of the CVT to achieve a desired result.

As discussed above, the controller 212 may be a TCU 212. Further in other embodiments, the controller 212 may be part of a vehicle controller, an engine controller or any other type of controller. In general, the controller 212 may include any one or more of a processor, microprocessor, a digital signal processor (DSP), an application specific integrated circuit (ASIC), a field program gate array (FPGA), or equivalent discrete or integrated logic circuitry. In some example embodiments, controller 212 may include multiple components, such as any combination of one or more microprocessors, one or more controllers, one or more DSPs, one or more ASICs, one or more FPGAs, as well as other discrete or integrated logic circuitry. The functions attributed to the controller herein may be embodied as software, firmware, hardware or any combination thereof. The controller 212 may be part of a system controller or a component controller. The memory 225 may include computer-readable operating instructions that, when executed by the controller 212 provides functions of altering the normal operating characteristics of the CVT 206. The computer readable instructions may be encoded within the memory. Memory 225 may comprise computer readable storage media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium.

In a NuVinci CVT example embodiment, the actuator 208 may include a brushed DC motor through a gear train. In response to an electrical voltage directed by the controller 212 to the actuator 208, the actuator 208 induces a change in the relative angle position of a set of carriers whose relative angular position to each other determines the ratio of the NuVinci CVT. In general, a NuVinci CVT is a friction device, the ratio is also affected by temperature and load but the active ratio control is accomplished through the relative angle of the two carriers.

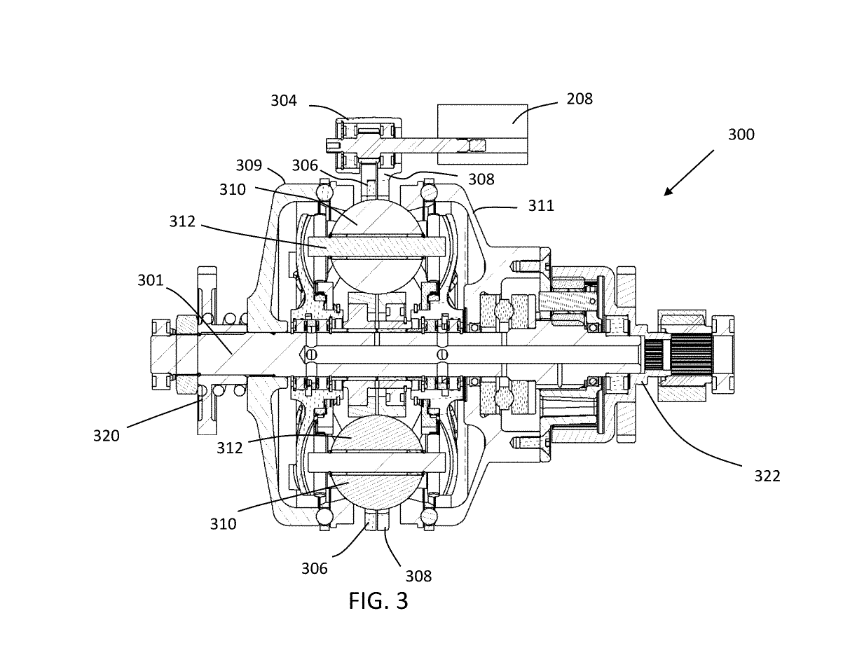

FIG. 3 illustrated a cross-sectional side view of NuVinci CVT 300 in an example embodiment. The CVT is mounted on a main shaft 301. Engine torque (power) is input to the main shaft 301 via gear 320 and exits at a select ratio via CVP output member 322 which is in rotational communication with the drivetrain 204. The CVT 300 includes a plurality of tilting balls 310 rotationally mounted on associated axles 312 position between an input disk member 309 and an output disk member 311.

The CVT 304 in this example embodiment is at least in part controlled by actuator 208 that is in turn controlled by the controller 212. Actuator 208, in this example embodiment, is an electric actuator. The actuator 208 is communicatively couple to a first carrier 306 via gearing 304. A second carrier 308 is locked rotationally to a transmission case. As the first carrier 316 is moved or rotated about its axis the axles 312 of the balls 310 move to a different angle thereby changing the CVP ratio. As discussed above, in embodiments, the shift mode switch 102 is used to select the operating parameters of CVT 304 via actuator 208.

In a belt CVT example embodiment, the actuator 208 may also include a DC motor that is activated by a voltage directed by the TCU 212. The DC motor is configured to control the axial spacing between the respective set of clutch sheaves. Hence, the actuator 208 may override a flyweight configuration depending on the mode selected and the operating conditions. The actuator 208 may control the relative clutch sheave positions without additional flyweights or other centrifugal ratio control mechanisms.

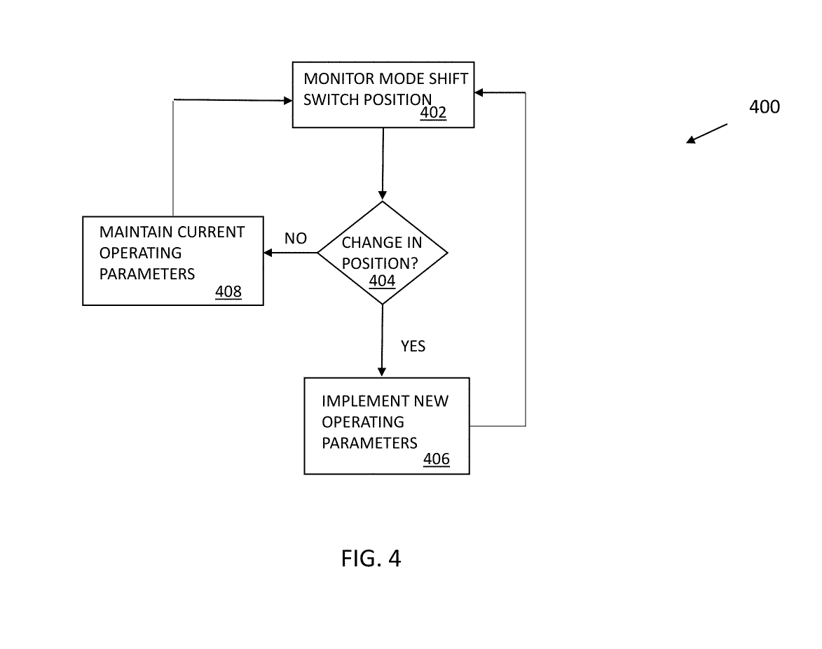

Referring to FIG. 4, an operating mode flow diagram 400 of one example embodiment is illustrated. The operating mode flow diagram is provided as a series of sequential steps. The sequence of steps may be different in other embodiments. Hence, embodiments are not limited to the sequence set out in FIG. 4.

In this example embodiment of FIG. 4, the shift mode switch position of the shift mode switch 102 is monitored at step (402). In one embodiment this is done with the controller 212. In one embodiment the controller 212 monitors by tracking a last selected mode position signal sent by the shift mode switch 102. In another embodiment, motioning is done by reading a current shift mode switch signal from the shift mode switch 102. Other forms of monitoring can be used.

If it is determined at step (404) that the shift mode switch position has not changed, the current operating parameter instructions are maintained by the controller 212 at step (408). The process then continues at step (402). If is determined that that there is a change in the shift mode switch at step (404), the controller then implements new operating instructions associated with the position of the shift mode switch at step (406). The process then continues monitoring at step (402).

In example embodiments, the shift mode switch 102 may used to switch between a relatively lower and relatively higher engine rpm for a given vehicle ground speed. The shift mode switch 102 may be used to switch between a relatively lower and relatively higher engine rpm relative to a given throttle input. The shift mode switch 102 may be used to switch between a given set of system parameter time constants and another given set of system parameter time constants. For example, a throttle value (percent, 0-100%) to the shift ratio lookup table is filtered from the raw signal of the throttle position sensor with a proportional response algorithm (asymptotic). One may desire a faster response for performance versus slower response for smoothness.

Further, the shift mode switch 102 in an embodiment may be used to switch between a given set of closed loop control proportional integral derivative (PID) parameters and another given set of closed loop control PID parameters. For example a closed loop control may be employed between the ratio shift actuator driver input and the calculated speed ratio of the drive in actual operation (utilizing speed sensors and a microprocessor). Closed loop control may be employed between the ratio shift actuator motor and the ratio shift actuator position sensor.

Algorithms implemented by the controller 212 may filter raw sensor value of one or more of the following TCU inputs; throttle position input speed, output speed, engine speed, temperature, lubrication pressure. TCU outputs may include one or more of the following; ratio control actuator signal, high temperature indication, and excessive CVT slip indication.

In embodiments, when operating a vehicle 200 in conditions that have steep ascents and descents, a user may chose a gear ratio shift strategy that results in a higher engine RPM for quicker throttle response and stronger engine braking. When operating a vehicle in conditions that are relatively level, the operator might chose a gear ratio shift strategy that results in a lower engine RPM for smoother throttle response and minimal engine noise.

A mode example includes “all-Purpose mode” aka “Normal” wherein the gear ratio is a function of throttle position as well as ground speed. Another mode example is a “hill mode”.

In a hill mode, a relatively higher engine RPM is used. This mode emphasis on quick ratio change response and a decreased ratio sensitivity to throttle position. Further another example of a mode is a “snow mode.” In a snow mode, a relatively lower engine RPM is used and an emphasis on smooth torque delivery through slow ratio change response is provided.

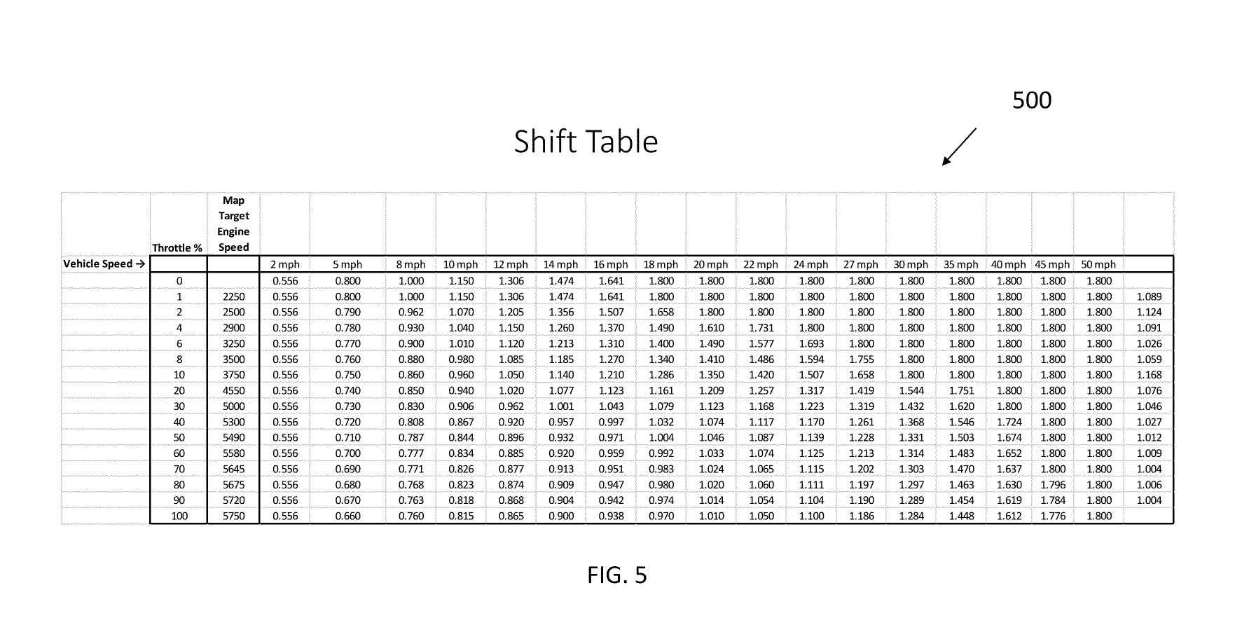

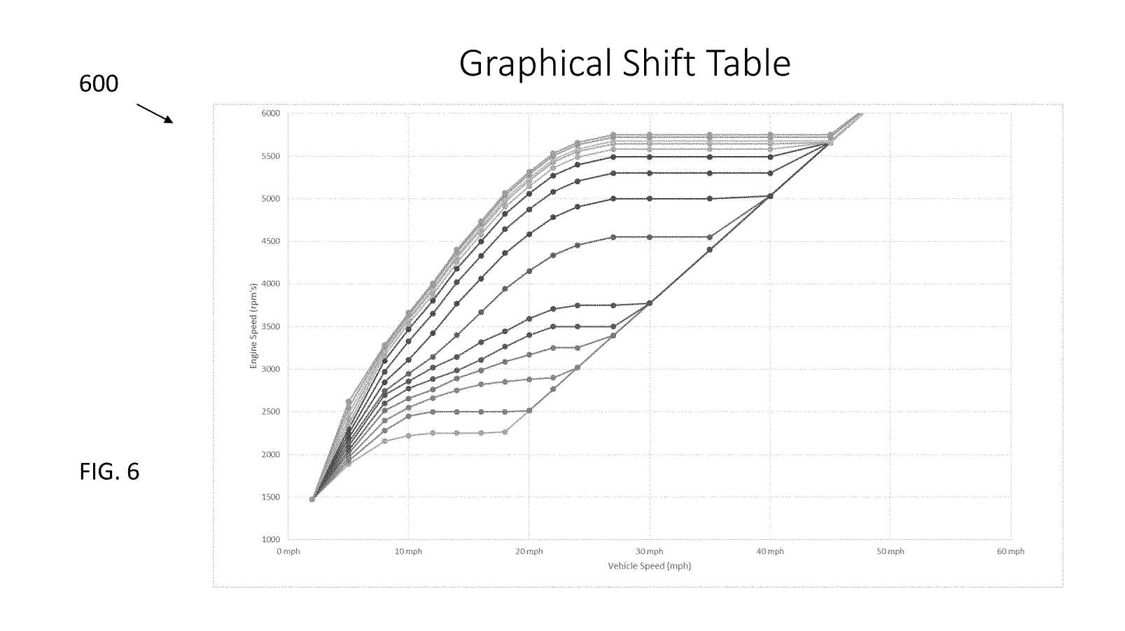

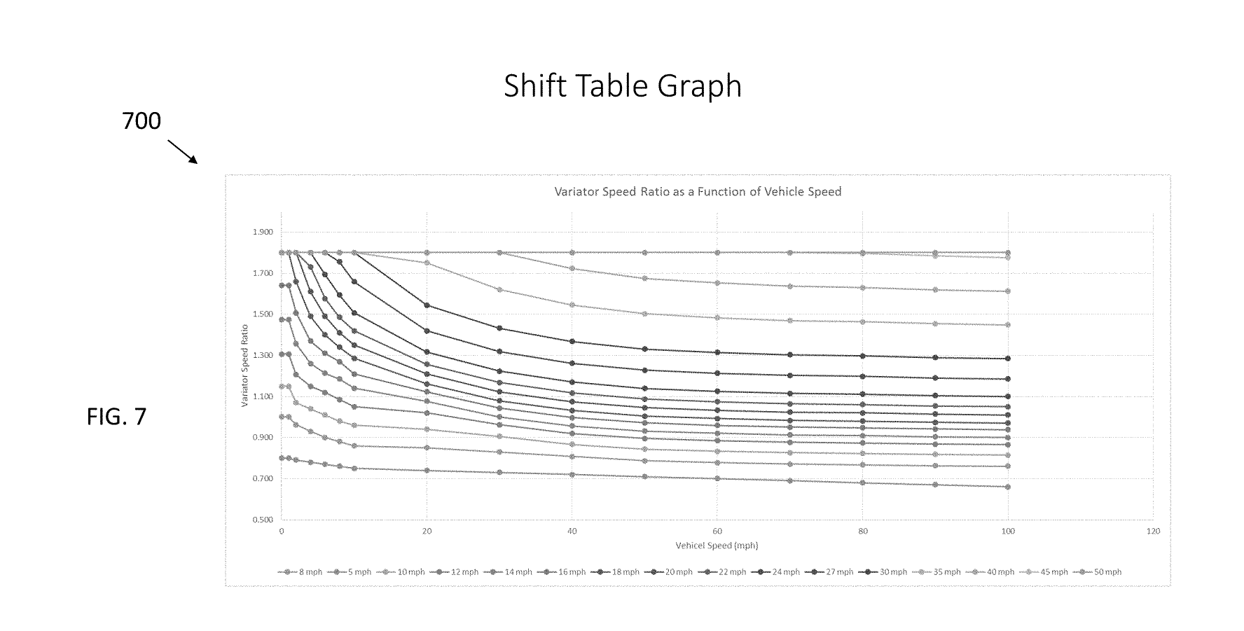

An example of a shift table 500 of variator speed ratios (inverse of gear ratios) of one example embodiment is illustrated in FIG. 5. In particular, the shift table illustrates desired variator speed ratios for a vehicle speed vs a mapped target engine speed and throttle percentage in an example embodiment. In an embodiment, the shift table (associated with a select modes) is stored in the memory 225 and implementing with the controller 206 when the select mode is selected by the shift mode switch 102. A graphical shift table 600 is illustrated in FIG. 6. The graphical shift table 600 plots the engine speed vs vehicle speed in an example embodiment. FIG. 7 illustrates an example shift table graph 700. The shift table graph 700 is a graph of a variator speed ratio as a function of vehicle speed.

### EXAMPLE EMBODIMENTS

Example 1 includes a control system for a continuously variable transmission (CVT). The control system includes a shift mode switch, an actuator and a controller. The shift mode switch is selectable between a plurality of modes. The actuator is in operational communication with the CVT to selectively override normal shifting characteristics of the CVT. The controller is in communication with the shift mode switch. The controller is configured to control the actuator to selectively override the normal shifting characteristics of the CVT based at least in part on a select mode configuration selected by the shift mode switch.

Example 2 includes the control system of Example 1, wherein the controller is a transmission control unit.

Example 3 includes the control system of any of the Examples 1-2, wherein the CVT is one of a belt CVT and a NuVinci CVT.

Example 4, includes the control system of any of the Examples 1-3, further including at least one sensor in communication with the controller. The controller is further configured to control the actuator to selectively override the normal shifting characteristics of the CVT based at least in part on received sensor information from the at least one sensor.

Example 5, includes the control system of any of the Examples 1-4, wherein the at least one sensor is at least one of an engine speed sensor, a CVT input speed sensor, a CVT output speed sensor, a temperature sensor and lubrication pressure sensor and a throttle position sensor.

Example 6, includes the control system of any of the Examples 1-5, further including a memory to store operating instructions and algorithms implemented by the controller.

Example 7, includes the control system of Example 6, wherein the memory further stores at least one table of variable speed ratios used by the controller based at least in part on a position of the shift mode switch and at least one of vehicle speed and throttle percentage.

Example 8, includes the control system of any of the Examples 1-7, further wherein the CVT is a NuVinci CVT and the controller is configured to manipulate one of a carrier of the CVT to adjust a ratio of the CVT.

Example 9 is a vehicle including a motor to generate engine torque, a drivetrain; a continuously variable transmission (CVT), a shift mode switch, an activator and a controller. The CVT is positioned to communicate torque between the motor and the drivetrain at a select ratio. The shift mode switch is selectable between a plurality of modes. The actuator is in operational communication with the CVT to selectively override normal shifting characteristics of the CVT. The controller is in communication with the shift mode switch. The controller is configured to control the actuator to selectively override the normal shifting characteristics of the CVT based at least in part on a select mode configuration selected by the shift mode switch.

Example 10 includes the vehicle of Example 9, wherein the controller is at least one of transmission control unit, a vehicle control unit and an engine control unit.

Example 11 includes the vehicle of any of the Examples 9-10, further including at least one sensor in communication with the controller. The controller further configured to control the actuator to selectively override the normal shifting characteristics of the CVT based at least in part on received sensor information from the at least one sensor.

Example 12 includes the vehicle of Examples 11, wherein the at least one sensor is at least one of an engine speed sensor, a CVT input speed sensor, a CVT output speed sensor, a temperature sensor and lubrication pressure sensor and a throttle position sensor.

Example 13 includes the vehicle of any of the Examples 9-12, further including a memory to store operating instructions and algorithms implemented by the controller.

Example 14 includes the vehicle of any of the Examples 9-13, wherein the memory further stores at least one table of variable speed ratios used by the controller based at least in part on a position of the shift mode switch and at least one of vehicle speed and throttle percentage.

Example 15 includes the vehicle of any of the Examples 9-14, further wherein the CVT is a NuVinci CVT and the controller is configured to manipulate one of a carrier of the CVT to adjust a gear ratio of the CVT.

Example 16 includes a method of controlling a continuously variable transmission (CVT). The method includes detecting the activation of a multi-mode shift mode switch; and implement operating instructions to adjust a shifting characteristics of the CVT associated with a mode indicated by the activated shift mode switch based at least in part on the position of the activated shift mode switch.

Example 17 includes the method of Example 16 wherein the mode is associated with one of an all-purpose mode, a hill mode and a snow mode.

Example 18 includes the method of any of the Examples 1-17, wherein the operating instructions include at least one of changing a gear ratio of the CVT based on an engine revolutions per minute (RPM) and given ground speed, changing an output ratio, changing a gear ratio of the CVT based on an engine revolutions per minute (RPM) to a given throttle output, changing a gear ratio of the CVT based on system parameter time constants.

Example 19 includes the method of any of the Examples 1-18, wherein the operating instructions include a given set of closed loop control parameters employed between a ratio shift actuator driver input and a calculated speed ratio of the drive in operation.

Example 20 includes the method of any of the Examples 1-19, further including setting a variator speed ratio of the CVT based at least in part on inputs of at least one of throttle position input speed, output speed, engine speed, temperature and lubrication pressure.

Although specific embodiments and examples have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A control system for a continuously variable transmission (CVT), the control system comprising:
a shift mode switch selectable between a plurality of modes;
an actuator in operational communication with the CVT to selectively override normal shifting characteristics of the CVT; and
a controller in communication with the shift mode switch, the controller configured to control the actuator to selectively override the normal shifting characteristics of the CVT based at least in part on a select mode configuration selected by the shift mode switch.

2. The control system of claim 1, wherein the controller is a transmission control unit.

3. The control system of claim 1, wherein the CVT is one of a belt CVT and a NuVinci CVT.

4. The control system of claim 1, further comprising:
at least one sensor in communication with the controller, the controller further configured to control the actuator to selectively override the normal shifting characteristics of the CVT based at least in part on received sensor information from the at least one sensor.

5. The control system of claim 1, wherein the at least one sensor is at least one of an engine speed sensor, a CVT input speed sensor, a CVT output speed sensor, a temperature sensor and lubrication pressure sensor and a throttle position sensor.

6. The control system of claim 1, further comprising:
a memory to store operating instructions and algorithms implemented by the controller.

7. The control system of claim 6, wherein the memory further stores at least one table of variable speed ratios used by the controller based at least in part on a position of the shift mode switch and at least one of vehicle speed and throttle percentage.

8. The control system of claim 1, further wherein:
the CVT is a NuVinci CVT; and
the controller is configured to manipulate one of a carrier of the CVT to adjust a ratio of the CVT.

9. A vehicle comprising:
a motor to generate engine torque;
a drivetrain;
a continuously variable transmission (CVT) positioned communicate torque between the motor and the drivetrain at a select ratio;
a shift mode switch selectable between a plurality of modes;
an actuator in operational communication with the CVT to selectively override normal shifting characteristics of the CVT; and
a controller in communication with the shift mode switch, the controller configured to control the actuator to selectively override the normal shifting characteristics of the CVT based at least in part on a select mode configuration selected by the shift mode switch.

10. The vehicle of claim 9, wherein the controller is at least one of transmission control unit, a vehicle control unit and an engine control unit.

11. The vehicle of claim 9, further comprising:
at least one sensor in communication with the controller, the controller further configured to control the actuator to selectively override the normal shifting characteristics of the CVT based at least in part on received sensor information from the at least one sensor.

12. The vehicle of claim 11, wherein the at least one sensor is at least one of an engine speed sensor, a CVT input speed sensor, a CVT output speed sensor, a temperature sensor and lubrication pressure sensor and a throttle position sensor.

13. The vehicle of claim 9, further comprising:
a memory to store operating instructions and algorithms implemented by the controller.

14. The vehicle of claim 13, wherein the memory further stores at least one table of variable speed ratios used by the controller based at least in part on a position of the shift mode switch and at least one of vehicle speed and throttle percentage.

15. The vehicle of claim 9, further wherein:
the CVT is a NuVinci CVT; and
the controller is configured to manipulate one of a carrier of the CVT to adjust a gear ratio of the CVT.

16. A method of controlling a continuously variable transmission (CVT), the method comprising:
detecting the activation of a multi-mode shift mode switch; and
implement operating instructions to adjust a shifting characteristics of the CVT associated with a mode indicated by the activated shift mode switch based at least in part on the position of the activated shift mode switch.

17. The method of claim 16, wherein the mode is associated with one of an all-purpose mode, a hill mode and a snow mode.

18. The method of claim 16, wherein the operating instructions include at least one of changing a gear ratio of the CVT based on an engine revolutions per minute (RPM) and given ground speed, changing an output ratio, changing a gear ratio of the CVT based on an engine revolutions per minute (RPM) to a given throttle output, changing a gear ratio of the CVT based on system parameter time constants.

19. The method of claim 16, wherein the operating instructions include a given set of closed loop control parameters employed between a ratio shift actuator driver input and a calculated speed ratio of the drive in operation.

20. The method of claim 16, further comprising:
setting a variator speed ratio of the CVT based at least in part on inputs of at least one of throttle position input speed, output speed, engine speed, temperature and lubrication pressure.
